(19) United States
(12) Patent Application Publication
(10) Pub. No.: US 2026/0100579 A1
(43) Pub. Date: Apr. 9, 2026

(54) MICROGRID DISTRIBUTED SECONDARY CONTROL METHOD AND SYSTEM BASED ON VIRTUAL SYNCHRONOUS MACHINE

(71) Applicants: Hainan Research Institute of Zhejiang University, Sanya (CN); Zhejiang University, Hangzhou (CN)

(72) Inventors: Xianbo WANG, Sanya (CN); Xing HUANG, Sanya (CN); Donglian QI, Sanya (CN); Yulin CHEN, Sanya (CN); Yunfeng YAN, Sanya (CN)

(73) Assignees: Hainan Research Institute of Zhejiang University, Sanya (CN); Zhejiang University, Hangzhou (CN)

(21) Appl. No.: 19/297,000

(22) Filed: Aug. 12, 2025

(30) Foreign Application Priority Data
Oct. 8, 2024 (CN) 202411389598.8

(51) Int. Cl. H02J 3/24; G06F 30/20; G06F 111/10; G06F 113/04; H02J 3/38

(52) U.S. Cl. CPC H02J 3/00142; G06F 30/20; H02J 3/381; G06F 2101/02; G06F 2111/10; G06F 2113/04; H02J 2103/30

(57) ABSTRACT

A microgrid distributed secondary control method and system based on a virtual synchronous machine is applied to the technical field of microgrid control. The microgrid distributed secondary control method includes: designing a microgrid primary control strategy based on the virtual synchronous machine, and establishing a microgrid distributed secondary control model based on the virtual synchronous machine by combining a speed regulator equation of the virtual synchronous machine; considering nonlinear characteristics of the virtual synchronous machine, based on a deterministic equivalence principle, designing a linearized microgrid distributed secondary control strategy based on the virtual synchronous machine; and based on the deterministic equivalence principle and a Lyapunov theory, proving accuracy of frequency recovery of the linearized microgrid distributed secondary control strategy based on the virtual synchronous machine. The method and system provides inertia support, significantly reduces communication and computing resources, and helps the microgrid to operate safely and stably.

### CROSS REFERENCE TO THE RELATED APPLICATIONS

This application is based upon and claims priority to Chinese Patent Application No. 202411389598.8, filed on Oct. 8, 2024, the entire contents of which are incorporated herein by reference.

### TECHNICAL FIELD

The present invention relates to the technical field of microgrid control, and in particular, to a microgrid distributed secondary control method and system based on a virtual synchronous machine.

### BACKGROUND

As large-scale renewable energy is integrated into the microgrid, grid inertia decreases dramatically, posing a huge challenge to power quality. The conventional droop control strategies lead to larger frequency deviations, threatening the operation of the system and thus seriously deteriorating the power quality; in addition, the conventional centralized control requires the central controller to communicate with renewable energy sources one by one, resulting in unnecessary communication and computing burdens.

Therefore, how to provide a microgrid distributed secondary control method and system based on a virtual synchronous machine that can provide inertia support for microgrid, reduce the frequency change rate and response time under load switching, and significantly reduce communication and computing resources is an urgent problem that needs to be solved by those skilled in the art.

### SUMMARY

In view of this, the present invention provides a microgrid distributed secondary control method and system based on a virtual synchronous machine.

To achieve the above objective, the present invention adopts the following technical solutions.

A microgrid distributed secondary control method based on a virtual synchronous machine includes:
step 1: designing a microgrid primary control strategy based on the virtual synchronous machine, and establishing a microgrid distributed secondary control model based on the virtual synchronous machine by combining a speed regulator equation of the virtual synchronous machine;
step 2: considering nonlinear characteristics of the virtual synchronous machine, based on a deterministic equivalence principle, designing a linearized microgrid distributed secondary control strategy based on the virtual synchronous machine; and
step 3: based on the deterministic equivalence principle and a Lyapunov theory, proving accuracy of frequency recovery of the linearized microgrid distributed secondary control strategy based on the virtual synchronous machine.

Optionally, in the step 1, the microgrid primary control strategy based on the virtual synchronous machine is as follows:

$${P}_{in} ( t ) - {P}_{i} ( t ) = {J}_{Mi} {ω}_{ni} ( t ) \frac{d ( {ω}_{i} ( t ) - {ω}_{ni} ( t ) )}{dt} + {D}_{Mi} ( {ω}_{i} ( t ) - \tilde{ω} ) ;$$

wherein Pᵢₙ(t) and Pᵢ(t) are a mechanical input active power and an output active power of the virtual synchronous machine i, respectively; J_{Mi} and D_{Mi} are a moment of inertia and a damping coefficient of the virtual synchronous machine i, respectively; ωᵢ(t) and ωₙᵢ (t) are an output frequency and a frequency setting value of the virtual synchronous machine i, respectively; and \tilde{ω} is a measured angular frequency of the virtual synchronous machine i.

Optionally, in the step 1, the speed regulator equation of the virtual synchronous machine is as follows:

$${k}_{ω i} ( {ω}_{ni} ( t ) - {ω}_{i} ( t ) ) = {P}_{in} ( t ) - {P}_{i}^{*} ;$$

wherein k_{ωi} is an adjustment coefficient; ωᵢ(t) and ωₙᵢ (t) are an output frequency and a frequency setting value of the virtual synchronous machine i, respectively; Pᵢₙ(t) is a mechanical input active power of the virtual synchronous machine i; and Pᵢ* is a rated active power of the virtual synchronous machine i.

Optionally, in the step 1, the microgrid distributed secondary control model based on the virtual synchronous machine is as follows:

$${\dot{θ}}_{ι} ( t ) = {ω}_{i} ( t ) ;$$

$${\dot{ω}}_{ι} ( t ) = \frac{1}{{J}_{i}} ( {P}_{i}^{*} - {P}_{i} ( t ) - {D}_{i} ( {ω}_{i} ( t ) - {ω}_{ni} ( t ) ) ) + {Ω}_{i} ( t ) = {Ω}_{i}^{ω} ( t ) ;$$

θᵢ(t) is a phase of a virtual synchronous machine i; ωᵢ (t) and ωₙᵢ (t) are an output frequency and a frequency setting value of the virtual synchronous machine i, respectively; Jᵢ=J_{Mi}ωₙᵢ (t) is an improved moment of inertia of the virtual synchronous machine i; Dᵢ=k_{ωi}+D_{Mi} is an improved damping coefficient of the virtual synchronous machine i; J_{Mi} and D_{Mi} are a moment of inertia and a damping coefficient of the virtual synchronous machine i, respectively; k_{ωi} is an adjustment coefficient; Pᵢ* is a rated active power of the virtual synchronous machine i; Pᵢ(t) is a mechanical output active power of the virtual synchronous machine i; Ωᵢ(t) and

$${Ω}_{i}^{ω} ( t )$$

are an error tracking auxiliary control coefficient and an auxiliary frequency control coefficient of the virtual synchronous machine i, respectively;
ωₙᵢ (t) is as follows:

$${ω}_{ni} ( t ) = \int ( {ψ}_{i} ( t ) + {Ω}_{i} ( t ) - \frac{1}{{k}_{{ω}_{i}}} {φ}_{i}^{P} ( t ) ) dt ;$$

wherein

$${φ}_{i}^{P} ( t )$$

is a derivative of quadratic compensation;
ψᵢ(t) is as follows:

$${ψ}_{i} ( t ) = \frac{1}{{J}_{i}} {( {P}_{i}^{*} - {P}_{i} ( t ) - {D}_{i} ( {ω}_{i} ( t ) - {ω}_{ni} ( t ) ) )}_{∘}$$

Optionally, in the step 2, the linearized microgrid distributed secondary control strategy based on the virtual synchronous machine is as follows:

$${z}_{i} ( t ) = {\hat{ω}}_{i} ( t ) - {ω}_{i} ( t ) ;$$

$${\dot{\hat{ω}}}_{i} ( t ) = {Ω}_{i}^{\hat{ω}} ( t ) ;$$

$${Ω}_{i} ( t ) = {γ}_{i} {z}_{i} ( t ) - {ψ}_{i} ( t ) + {Ω}_{i}^{\hat{ω}} ( t ) ;$$

zᵢ (t) is an estimated error; \hat{ω}ᵢ(t) is an estimated value of ωᵢ(t); ωᵢ(t) is an output frequency of the virtual synchronous machine i;

$${Ω}_{i}^{\hat{ω}} ( t )$$

is a control variable of reference value tracking; Ωᵢ(t) is an error tracking auxiliary control coefficient of the virtual synchronous machine i; γᵢ is a control gain; ψᵢ(t) is as follows:

$${ψ}_{i} ( t ) = \frac{1}{{J}_{i}} ( {P}_{i}^{*} - {P}_{i} ( t ) - {D}_{i} ( {ω}_{i} ( t ) - {ω}_{ni} ( t ) ) ) ;$$

Jᵢ=J_{Mi}ωₙᵢ (t) is an improved moment of inertia of the virtual synchronous machine i; Dᵢ=k_{ωi}+D_{Mi} is an improved damping coefficient of the virtual synchronous machine i, J_{Mi} and D_{Mi} are a moment of inertia and a damping coefficient of the virtual synchronous machine i, respectively; k_{ωi} is an adjustment coefficient;

$${P}_{i}^{*}$$

is a rated active power of the virtual synchronous machine i; Pᵢ(t) is a mechanical output active power of the virtual synchronous machine i; ωₙᵢ (t) is a frequency setting value of virtual synchronous machine i;
Ωᵢ^{\hat{ω}}(t) is as follows:

$${Ω}_{i}^{\hat{ω}} ( t ) = {σ}_{ω} {λ}_{i} ( t ) ;$$

wherein σ_{ω} is a control gain; λᵢ(t) is an auxiliary control variable;
ψᵢ(t) is as follows:

$${λ}_{i} ( t ) = - {\sum }_{j ∈ {N}_{i}} {a}_{ij} ( {ω}_{i} ( t ) - {ω}_{j} ( t ) ) - {g}_{i 0} ( {ω}_{i} ( t ) - {ω}_{i}^{ref} ) - {β}_{i} {z}_{i} ( t ) ;$$

Nᵢ is a set of neighbors of the virtual synchronous machine i; αᵢⱼ is a connection gain; gᵢ₀=I means that the virtual synchronous machine i is connected to a reference value;

$${ω}_{i}^{ref}$$

is a frequency reference value; βᵢ is a consensus control gain;

$${ω}_{i}^{ref}$$

is as follows:

$${ω}_{i}^{ref} = {lim}_{t \to ∞} {ω}_{i} ( t ) ;$$

wherein i=1, 2, . . . , n.

Optionally, the step 3 of, based on the deterministic equivalence principle and a Lyapunov theory, proving accuracy of frequency recovery of the linearized microgrid distributed secondary control strategy based on the virtual synchronous machine is specifically as follows:
step 3.1: proving that the frequency ωᵢ(t) approaches a frequency estimate \hat{ω}ᵢ(t); and
step 3.2: proving that the frequency estimate \hat{ω}ᵢ(t) approaches a frequency reference

$${ω}_{i}^{ref} .$$

Optionally, in the step 3.1, the proving that the frequency ωᵢ(t) approaches a frequency estimate \hat{ω}ᵢ(t) is specifically as follows:
deriving an estimation error zᵢ (t), as follows:

$${\dot{z}}_{i} ( t ) = {\dot{\hat{ω}}}_{t} ( t ) - {\dot{ω}}_{i} ( t ) = - {γ}_{i} {z}_{i} ( t ) ;$$

defining a Lyapunov function V₁(t), as follows:

$${V}_{1} ( t ) = \frac{1}{2} {z}^{T} z ;$$

wherein z=[z₁,z₂, . . . ,zₙ]^{T}; T is the transpose;
deriving the lyapunov function V₁(t) to obtain:

$${\dot{V}}_{1} ( t ) = \frac{1}{2} {z}^{T} \dot{z} = - γζ \leq 0 ;$$

wherein γ=diag{γᵢ}⊆ [symbol] ^{N×N}.

$$ζ = diag \{ {z}_{i}^{2} \} ⊆ {ℝ}^{N \times N} ;$$

γᵢ is a control gain;

$${z}_{i}^{2}$$

is a parameter form;
when γᵢ>0, \dot{V}₁(t)<0, and the frequency ωᵢ (t) approaches the frequency estimate \hat{ω}ᵢ(t).

Optionally, in the step 3.2, the proving that the frequency estimate \hat{ω}ᵢ(t) approaches a frequency reference

$${ω}_{i}^{ref}$$

is specifically as follows:
defining ñᵢ(t), χᵢ(t), and θᵢ(t), as follows:

$${\tilde{n}}_{i} ( t ) = - {β}_{i} {z}_{i} ( t ) ;$$

$${χ}_{i} ( t ) = {ω}_{i} ( t ) - {ω}_{i}^{ref} ;$$

$${ϑ}_{i} ( t ) = - {\sum }_{j ∈ {N}_{i}} {a}_{ij} ( {ω}_{i} ( t ) - {ω}_{j} ( t ) ) - {g}_{i 0} ( {ω}_{i} ( t ) - {ω}_{i}^{ref} ) ;$$

expressing the linearized microgrid distributed secondary control strategy based on the virtual synchronous machine in a matrix form, as follows:

$$ω = {σ}_{ω} ϑ + {σ}_{ω} \tilde{n} ;$$

wherein ω is in matrix form; θ=−(L+B)χ; L+B is a matrix form of the connection status; ñ is in matrix form;
defining a Lyapunov function V₂(t), as follows:

$${V}_{2} ( t ) = \frac{1}{2} {χ}^{T} ( L + B ) χ ;$$

wherein χ=[χ₁,χ₂, . . . ,χ_{N}]^{T};
deriving the lyapunov function V₂(t) to obtain:

$${\dot{V}}_{2} ( t ) = {χ}^{T} ( L + B ) χ ;$$

based on χ=ω and (L+B)^{T}=(L+B), obtaining:

$${\dot{V}}_{2} ( t ) = - {σ}_{ω} {ϑ}^{T} ϑ - {σ}_{ω} {ϑ}^{T} \tilde{n} ;$$

scaling \dot{V}₂(t), and obtaining:

$${\dot{V}}_{2} ( t ) \leq - \frac{{σ}_{ω}}{2} {\sum }_{i = 1}^{N} ( {ϑ}_{i}^{2} ( t ) - {\tilde{n}}_{i}^{2} ( t ) ) ;$$

since a convergence parameter u; satisfies

$${ϑ}_{i}^{2} ( t ) < {μ}_{i} {\tilde{n}}_{i}^{2} ( t )$$

and μᵢ>1, obtaining:

$${\dot{V}}_{2} ( t ) \leq - \frac{{σ}_{ω}}{2} {\sum }_{i = 1}^{N} ( {μ}_{i} - 1 ) {\tilde{n}}_{i}^{2} ( t ) \leq 0 ;$$

wherein \dot{V}₂(t) is strictly negative semi-definite, and the frequency estimate \hat{ω}ᵢ(t) approaches the frequency reference

$${ω}_{i}^{ref} .$$

The present invention further provides a microgrid distributed secondary control system based on a virtual synchronous machine using the microgrid distributed secondary control method based on the virtual synchronous machine, which includes:
an establishment module for a microgrid distributed secondary control model based on a virtual synchronous machine, configured to, design a microgrid primary control strategy based on the virtual synchronous machine, and establish a microgrid distributed secondary control model based on the virtual synchronous machine by combining a speed regulator equation of the virtual synchronous machine;
a designing module for a linearized microgrid distributed secondary control strategy based on a virtual synchronous machine, configured to, consider nonlinear characteristics of the virtual synchronous machine, and based on a deterministic equivalence principle, design a linearized microgrid distributed secondary control strategy based on the virtual synchronous machine; and
a frequency recovery accuracy proof module, configured to, based on the deterministic equivalence principle and a Lyapunov theory, prove accuracy of frequency recovery of the linearized microgrid distributed secondary control strategy based on the virtual synchronous machine.

It can be known from the technical solutions that, compared with the prior art, the present invention provides a microgrid distributed secondary control method and system based on a virtual synchronous machine. Based on the construction of a virtual synchronous machine model, the present invention designs a distributed secondary control strategy based on the virtual synchronous machine to provide inertia support for microgrid operation and reduce the frequency change rate and response time under load switching. The present invention designs a distributed control strategy based on the conventional centralized communication strategy, which significantly reduces communication and computing resources. In summary, compared with the conventional centralized secondary control strategy, the present invention provides inertia support, significantly reduces communication and computing resources, and helps the microgrid to operate safely and stably.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

To more clearly illustrate technical solutions in embodiments of the present invention or in the prior art, the following briefly introduces accompanying drawings required in the embodiments or the prior art. It is clear that the accompanying drawings in the following descriptions are only embodiments of the present invention, and a person of ordinary skill in the art may still derive other drawings from the accompanying drawings without creative efforts.

FIG. 1 is a schematic flow chart of a method according to the present invention.

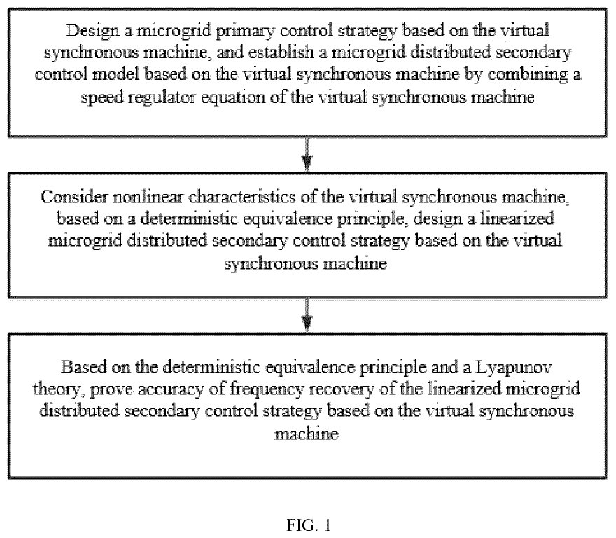

FIG. 2 is a schematic diagram of a structure of an island microgrid system according to the present invention.

FIG. 3 is a schematic diagram of frequencies of virtual synchronous machines under a microgrid distributed secondary control strategy based on a virtual synchronous machine according to the present invention.

FIG. 4 is a schematic diagram of active power of virtual synchronous machines under a microgrid distributed secondary control strategy based on a virtual synchronous machine according to the present invention.

### DETAILED DESCRIPTION OF THE EMBODIMENTS

The following clearly and completely describes the technical solutions in embodiments of the present invention with reference to the accompanying drawings in embodiments of the present invention. It is clear that the described embodiments are merely a part rather than all of embodiments of the present invention. Based on the embodiments of the present invention, all other embodiments obtained by those of ordinary skill in the art without creative efforts shall fall within the protection scope of the present invention.

### Embodiment 1

Embodiment 1 of the present invention discloses a microgrid distributed secondary control method and system based on a virtual synchronous machine.

To achieve the above objective, the present invention adopts the following technical solutions.

A microgrid distributed secondary control method based on a virtual synchronous machine includes:
Step 1: A microgrid primary control strategy based on the virtual synchronous machines is designed, so that inertia support is provided for operation of the microgrid, and rapid balance of the virtual synchronous machines under load change is achieved; a microgrid distributed secondary control model based on the virtual synchronous machines is established by combining with a speed regulator equation of the virtual synchronous machines, so that inertia support is provided for operation of the microgrid, and instantaneous frequency offset is reduced.

The microgrid primary control strategy based on the virtual synchronous machine is as follows:

$${P}_{in} ( t ) - {P}_{i} ( t ) = {J}_{Mi} {ω}_{ni} ( t ) \frac{d ( {ω}_{i} ( t ) - {ω}_{ni} ( t ) )}{dt} + {D}_{Mi} ( {ω}_{i} ( t ) - \tilde{ω} ) ;$$

wherein Pᵢₙ(t) and Pᵢ(t) are a mechanical input active power and an output active power of the virtual synchronous machine i, respectively; J_{Mi} and D_{Mi} are a moment of inertia and a damping coefficient of the virtual synchronous machine i, respectively; ωᵢ (t) and ωₙᵢ (t) are an output frequency and a frequency setting value of the virtual synchronous machine i, respectively; and \tilde{ω} is a measured angular frequency of the virtual synchronous machine i, \tilde{ω}=ωₙᵢ(t).

The speed regulator equation of the virtual synchronous machine is as follows:

$${k}_{ω i} ( {ω}_{ni} ( t ) - {ω}_{i} ( t ) ) = {P}_{in} ( t ) - {P}_{i}^{*} ;$$

wherein k_{ωi} is an adjustment coefficient; ωᵢ (t) and ωₙᵢ (t) are an output frequency and a frequency setting value of the virtual synchronous machine i, respectively; Pᵢₙ(t) is a mechanical input active power of the virtual synchronous machine i; and

$${P}_{i}^{*}$$

is a rated active power of the virtual synchronous machine i.

The microgrid distributed secondary control model based on the virtual synchronous machine is as follows:

$${\dot{θ}}_{ι} ( t ) = {ω}_{i} ( t ) ;$$

$${\dot{ω}}_{ι} ( t ) = \frac{1}{{J}_{i}} ( {P}_{i}^{*} - {P}_{i} ( t ) - {D}_{i} ( {ω}_{i} ( t ) - {ω}_{n i} ( t ) ) ) + {Ω}_{i} ( t ) = {Ω}_{i}^{ω} ( t ) ;$$

θᵢ(t) is a phase of a virtual synchronous machine i; ωᵢ(t) and ωₙᵢ (t) are an output frequency and a frequency setting value of the virtual synchronous machine i, respectively; Jᵢ=J_{Mi}ωₙᵢ (t) is an improved moment of inertia of the virtual synchronous machine i; Dᵢ=k_{ωi}+D_{Mi} is an improved damping coefficient of the virtual synchronous machine i; J_{Mi} and D_{Mi} are a moment of inertia and a damping coefficient of the virtual synchronous machine i, respectively; k_{ωi} is an adjustment coefficient;

$${P}_{i}^{*}$$

is a rate active power of the virtual synchronous machine i; Pᵢ(t) is a mechanical output active power of the virtual synchronous machine i; Ωᵢ(t) and Ωᵢ^{ω}(t) are an error tracking auxiliary control coefficient and an auxiliary frequency control coefficient of the virtual synchronous machine i, respectively;
quadratic compensation dPᵢ(t) is defined as follows:

$${ω}_{i} ( t ) - {ω}_{n i} ( t ) = \frac{1}{{k}_{{ω}_{i}}} {dP}_{i} ( t ) ;$$

the quadratic compensation dPᵢ(t) is derived as follows:

$${\dot{ω}}_{i} ( t ) - {\dot{ω}}_{n i} ( t ) = \frac{1}{{k}_{{ω}_{i}}} d {\dot{P}}_{i} ( t ) ;$$

$$d {\dot{P}}_{i} ( t ) = {φ}_{i}^{P} ( t )$$

is defined, so that the frequency setting ωₙᵢ (t) is as follows:

$${ω}_{n i} ( t ) = \int ( {\dot{ω}}_{i} ( t ) - \frac{1}{{k}_{{ω}_{i}}} d {\dot{P}}_{i} ( t ) ) dt = \int ( {\dot{ω}}_{i} ( t ) - \frac{1}{{k}_{{ω}_{i}}} {φ}_{i}^{P} ( t ) ) dt = \int ( {ψ}_{i} ( t ) + {Ω}_{i} ( t ) - \frac{1}{{k}_{{ω}_{i}}} {φ}_{i}^{P} ( t ) ) dt ;$$

wherein

$${φ}_{i}^{P} ( t )$$

is a derivative or quadratic compensation;
ψᵢ(t) is as follows:

$${ψ}_{i} ( t ) = \frac{1}{{J}_{i}} ( {P}_{i}^{*} - {P}_{i} ( t ) - {D}_{i} ( {ω}_{i} ( t ) - {ω}_{n i} ( t ) ) ) .$$

Step 2: Nonlinear characteristics of the virtual synchronous machine are considered, and based on a deterministic equivalence principle, a linearized microgrid distributed secondary control strategy based on the virtual synchronous machine is designed. Considering the nonlinear characteristics of the virtual synchronous machine, the deterministic equivalence principle is used to achieve the linearization of the virtual synchronous machine. A distributed frequency recovery control strategy of the virtual synchronous machine is designed to restore the frequency of each virtual synchronous machine to the rated reference.

The secondary frequency control target is to restore the frequency of each virtual synchronous machine to the frequency reference, as follows:

$${lim}_{t \to ∞} {ω}_{i} ( t ) = {ω}_{i}^{ref} ;$$

wherein i=1, 2, . . . , n;

$${ω}_{i}^{ref}$$

is a frequency reference.

The nonlinear characteristic of the virtual synchronous machine is considered, the linearization of the virtual synchronous machine is achieved d by applying a deterministic equivalence principle, and the linearized microgrid distributed secondary control strategy based on the virtual synchronous machine is as follows:

$${z}_{i} ( t ) = {\hat{ω}}_{i} ( t ) - {ω}_{i} ( t ) ;$$

$${\dot{\hat{ω}}}_{i} ( t ) = {Ω}_{i}^{\hat{ω}} ( t ) ;$$

$${Ω}_{i} ( t ) = {γ}_{i} {z}_{i} ( t ) - {ψ}_{i} ( t ) + {Ω}_{i}^{\hat{ω}} ( t ) ;$$

zᵢ (t) is an estimated error; \hat{ω}ᵢ(t) is an estimated value of ωᵢ(t); ωᵢ(t) is an output frequency of the virtual synchronous machine i;

$${Ω}_{i}^{\hat{ω}} ( t )$$

is a control variable of reference value tracking; Ωᵢ(t) is an error tracking auxiliary control coefficient of the virtual synchronous machine i; γᵢ is a control gain; ψᵢ(t) is as follows:

$${ψ}_{i} ( t ) = \frac{1}{{J}_{i}} ( {P}_{i}^{*} - {P}_{i} ( t ) - {D}_{i} ( {ω}_{i} ( t ) - {ω}_{n i} ( t ) ) ) ;$$

Jᵢ=J_{Mi}ωₙᵢ (t) is an improved moment of inertia of the virtual synchronous machine i; Dᵢ=k_{ωi}+D_{Mi} is an improved damping coefficient of the virtual synchronous machine i, J_{Mi} and D_{Mi} are a moment of inertia and a damping coefficient of the virtual synchronous machine i, respectively; k_{ωi} is an adjustment coefficient;

$${P}_{i}^{*}$$

is a rated active power of the virtual synchronous machine i; Pᵢ(t) is a mechanical output active power of the virtual synchronous machine i; ωₙᵢ (t) is a frequency setting value of virtual synchronous machine i;
Ωᵢ^{\hat{ω}}(t) is as follows:

$${Ω}_{i}^{\hat{ω}} ( t ) = {σ}_{ω} {λ}_{i} ( t ) ;$$

wherein σ_{ω} is a control gain; λᵢ(t) is an auxiliary control variable;
ψᵢ(t) is as follows:

$${λ}_{i} ( t ) = - {\sum }_{j ∈ {N}_{i}} {a}_{ij} ( {ω}_{i} ( t ) - {ω}_{j} ( t ) ) - {g}_{i 0} ( {ω}_{i} ( t ) - {ω}_{i}^{ref} ) - {β}_{i} {z}_{i} ( t ) ;$$

Nᵢ is a set of neighbors of the virtual synchronous machine i; αᵢⱼ is a connection gain; gᵢ₀=1 means that the virtual synchronous machine i is connected to a reference value;

$${ω}_{i}^{ref}$$

is a frequency reference value; βᵢ is a consensus control gain;

$${ω}_{i}^{ref}$$

is as follows:

$${ω}_{i}^{ref} = {lim}_{t \to ∞} {ω}_{i} ( t ) ;$$

wherein i=1, 2, . . . , n.

Step 3: Based on the deterministic equivalence principle and a Lyapunov theory, the accuracy of frequency recovery of the linearized microgrid distributed secondary control strategy based on the virtual synchronous machine is proved, so that inertia support is provided.

The step of, based on the deterministic equivalence principle and a Lyapunov theory, proving accuracy of frequency recovery of the linearized microgrid distributed secondary control strategy based on the virtual synchronous machine, is specifically as follows:

Step 3.1: Proving that the frequency ωᵢ(t) approaches a frequency estimate \hat{ω}ᵢ(t).
the proving that the frequency ωᵢ(t) approaches a frequency estimate \hat{ω}ᵢ(t) is specifically as follows:
deriving an estimation error zᵢ(t), as follows:

$${\dot{z}}_{i} ( t ) = {\dot{\hat{ω}}}_{t} ( t ) - {\dot{ω}}_{i} ( t ) = - {γ}_{i} {z}_{i} ( t ) ;$$

defining a Lyapunov function V₁(t), as follows:

$${V}_{1} ( t ) = \frac{1}{2} {z}^{T} z ;$$

wherein z=[z₁,z₂, . . . ,zₙ]^{T}; T is the transpose;
deriving the lyapunov function V₁(t) to obtain:

$${\dot{V}}_{1} ( t ) = \frac{1}{2} {z}^{T} \dot{z} = - γζ \leq 0 ;$$

wherein γ=diag{γᵢ}⊆ [symbol] ^{N×N}.

$$ζ = diag \{ {z}_{i}^{2} \} ⊆ {ℝ}^{N \times N} ;$$

γᵢ is a control gain;

$${z}_{i}^{2}$$

is a parameter form for the convenience of writing;
when γᵢ>0, \dot{V}₁(t)<0, and the frequency ωᵢ(t) approaches the frequency estimate \hat{ω}ᵢ(t).

Step 3.2: Proving that the frequency estimate \hat{ω}ᵢ(t) approaches a frequency reference

$${ω}_{i}^{ref} .$$

The proving that the frequency estimate \hat{ω}ᵢ(t) approaches a frequency reference

$${ω}_{i}^{ref}$$

is specifically as follows:
defining ñᵢ(t), χᵢ(t), and θᵢ(t), as follows:

$${\tilde{n}}_{i} ( t ) = - {β}_{i} {z}_{i} ( t ) ;$$

$${χ}_{i} ( t ) = {ω}_{i} ( t ) - {ω}_{i}^{ref} ;$$

$${ϑ}_{i} ( t ) = - {\sum }_{j ∈ {N}_{i}} {a}_{ij} ( {ω}_{i} ( t ) - {ω}_{j} ( t ) ) - {g}_{i 0} ( {ω}_{i} ( t ) - {ω}_{i}^{ref} ) ;$$

expressing the linearized microgrid distributed secondary control strategy based on the virtual synchronous machine in a matrix form, as follows:

$$ω = {σ}_{ω} ϑ + {σ}_{ω} \tilde{n} ;$$

wherein ω is in matrix form; θ=−(L+B)χ; L+B is a matrix form of the connection status; ñ is in matrix form;
defining a Lyapunov function V₂(t), as follows:

$${V}_{2} ( t ) = \frac{1}{2} {χ}^{T} ( L + B ) χ ;$$

wherein χ=[χ₁,χ₂, . . . ,χ_{N}]^{T};
deriving the lyapunov function V₂(t) to obtain:

$${\dot{V}}_{2} ( t ) = {χ}^{T} ( L + B ) χ ;$$

based on χ=ω and (L+B)^{T}=(L+B), obtaining:

$${\dot{V}}_{2} ( t ) = - {σ}_{ω} {ϑ}^{T} ϑ - {σ}_{ω} {ϑ}^{T} \tilde{n} ;$$

scaling \dot{V}₂(t), and obtaining:

$${\dot{V}}_{2} ( t ) \leq - \frac{{σ}_{ω}}{2} {\sum }_{i = 1}^{N} ( {ϑ}_{i}^{2} ( t ) - {\tilde{n}}_{i}^{2} ( t ) ) ;$$

since a convergence parameter μᵢ satisfies

$${ϑ}_{i}^{2} ( t ) < {μ}_{i} {\tilde{n}}_{i}^{2} ( t )$$

and μᵢ>1, obtaining:

$${\dot{V}}_{2} ( t ) \leq - \frac{{σ}_{ω}}{2} {\sum }_{i = 1}^{N} ( {μ}_{i} - 1 ) {\tilde{n}}_{i}^{2} ( t ) \leq 0 ;$$

wherein \dot{V}₂(t) is strictly negative semi-definite, and the frequency estimate \hat{ω}ᵢ(t) approaches the frequency reference

$${ω}_{i}^{r e f} .$$

### Embodiment 2

Embodiment 2 of the present invention discloses a specific application of the microgrid distributed secondary control method based on the virtual synchronous machine, as follows:

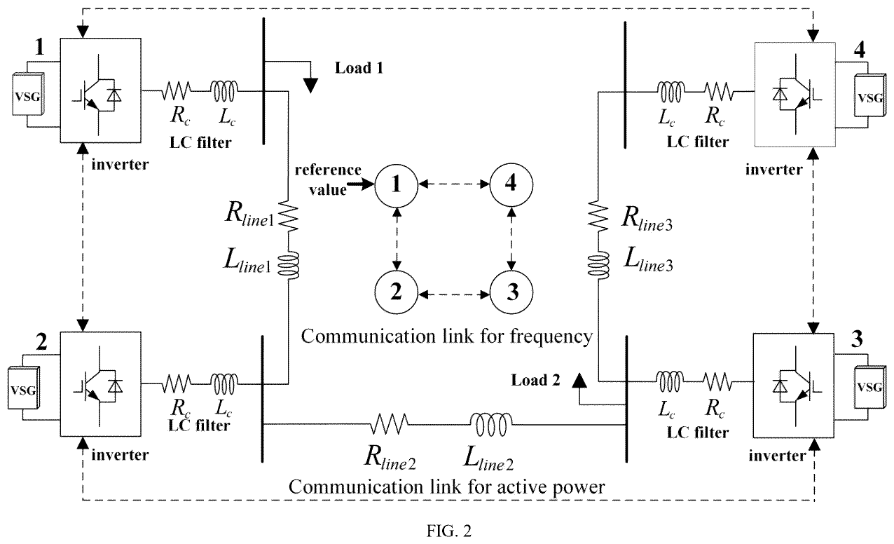

An island microgrid system is shown in FIG. 2, and the system parameters are shown in Table 1.

TABLE 1
Parameters of island microgrid system

| Virtual | DG1&2 (10.64 kW) | | | DG3&4 (8.0 kW) | | |
|---|---|---|---|---|---|---|
| synchronous | D | J | | D | J | |
| machine | 9.85 | 0.1692 | | 7.4 | 0.225 | |
| | R_{c} | L_{c} | | R_{c} | L_{c} | |
| | 0.2 | 3 × 10⁻³ | | 0.2 | 3 × 10⁻³ | |
| Line | Line 1 | | Line 2 | | Line 3 | |
| | R_{Line1} | L_{Line1} | R_{Line2} | L_{Line2} | R_{Line3} | L_{Line3} |
| | 0.23 | 0.318 × 10⁻³ | 0.35 | 1.847 × 10⁻³ | 0.23 | 0.318 × 10⁻³ |

| Load | Load 1 | | Load 2 | |
|---|---|---|---|---|
| | P_{Load1} | Q_{Load1} | P_{load2} | Q_{Load2} |
| | 10 × 10³ | 15 × 10³ | 15.6 × 10³ | 7.6 × 10³ |

To verify the effectiveness of the proposed microgrid distributed secondary control strategy based on the virtual synchronous machine, the simulation process is designed as follows:
1) t=0 s, the microgrid enters the island operation mode;
2) t=1.5 s, using the proposed microgrid distributed secondary control strategy based on the virtual synchronous machine;
3) t=4 s, load 1 increases by 3 kW;
4) t=6 s, load 1 reduces by 3 kW.

The total simulation time is 8 s.

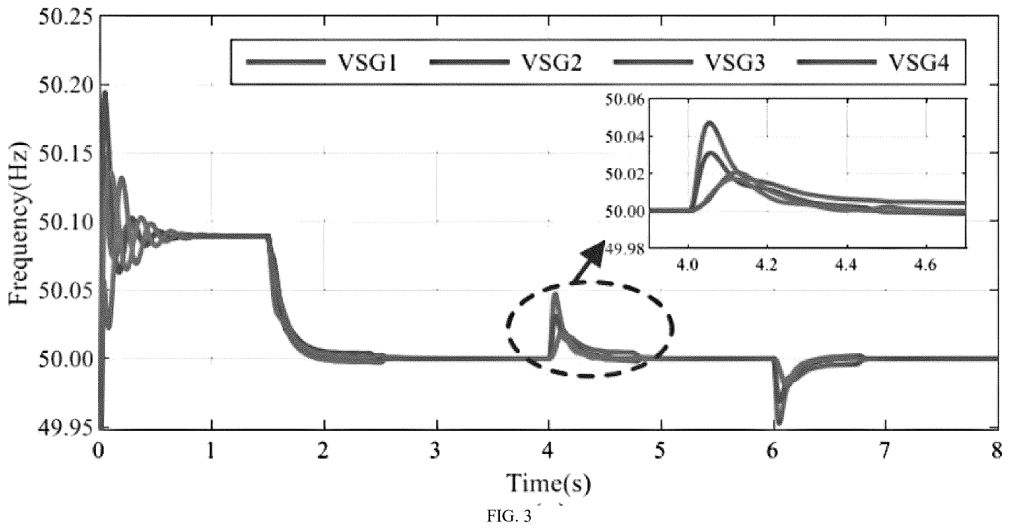

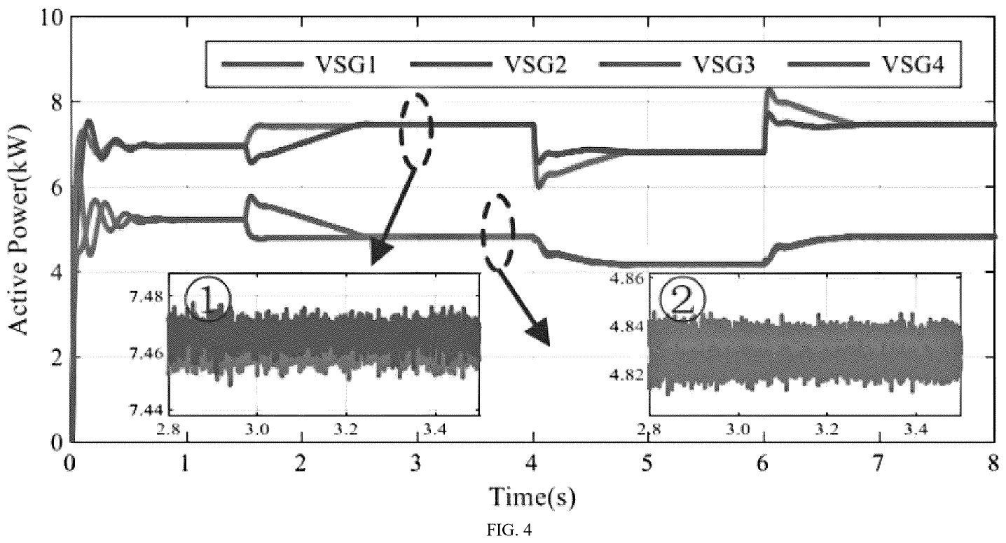

The schematic diagrams of the frequency and active power of each virtual synchronous machine under the microgrid distributed secondary control strategy based on the virtual synchronous machines proposed in the present invention are shown in FIG. 3 and FIG. 4, respectively. It may be seen that, during the period of 0-1.5 s, the output frequency of each virtual synchronous machine is lower than 50 Hz; when t=1.5 s, the microgrid distributed secondary control strategy based on the virtual synchronous machine proposed in the present invention is used, and the frequency of each virtual synchronous machine is accurately restored to 50 Hz, and active power distribution is achieved. This performance verifies the effectiveness of the microgrid distributed secondary control strategy based on the virtual synchronous machines proposed in the present invention.

### Embodiment 3

Embodiment 3 of the present invention discloses a microgrid distributed secondary control system based on a virtual synchronous machine using the microgrid distributed secondary control method based on the virtual synchronous machine, which includes:
an establishment module for a microgrid distributed secondary control model based on a virtual synchronous machine, configured to, design a microgrid primary control strategy based on the virtual synchronous machine, and establish a microgrid distributed secondary control model based on the virtual synchronous machine by combining a speed regulator equation of the virtual synchronous machine;
a designing module for a linearized microgrid distributed secondary control strategy based on a virtual synchronous machine, configured to, consider nonlinear characteristics of the virtual synchronous machine, and based on a deterministic equivalence principle, design a linearized microgrid distributed secondary control strategy based on the virtual synchronous machine; and
a frequency recovery accuracy proof module, configured to, based on the deterministic equivalence principle and a Lyapunov theory, prove accuracy of frequency recovery of the linearized microgrid distributed secondary control strategy based on the virtual synchronous machine.

The embodiments of the present invention discloses a microgrid distributed secondary control method and system based on a virtual synchronous machine. Based on the construction of a virtual synchronous machine model, the present invention designs a distributed secondary control strategy based on the virtual synchronous machine to provide inertia support for microgrid operation and reduce the frequency change rate and response time under load switching. The present invention designs a distributed control strategy based on the conventional centralized communication strategy, which significantly reduces communication and computing resources. In summary, compared with the conventional centralized secondary control strategy, the present invention provides inertia support, significantly reduces communication and computing resources, and helps the microgrid to operate safely and stably.

Embodiments in this specification are all described in a progressive manner, for same or similar parts in embodiments, reference may be made to these embodiments, and each embodiment focuses on a difference from other embodiments. The apparatus disclosed in embodiments corresponds to the apparatus disclosed in embodiments, and therefore is briefly described. For related parts, refer to the descriptions of the apparatus.

The foregoing descriptions of the disclosed embodiments enables a person skilled in the art to implement or use the present invention. The various modifications to the embodiments are clear to a person skilled in the art, and the general principles defined herein may be implemented in another embodiment without departing from the spirit or scope of the present invention. Therefore, the present invention is not limited to the embodiments shown herein, but the present invention needs to conform to the widest range consistent with the principles and novel features disclosed herein.

1. A microgrid distributed secondary control method based on a virtual synchronous machine, comprising:
step 1: designing a microgrid primary control strategy based on the virtual synchronous machine, and establishing a microgrid distributed secondary control model based on the virtual synchronous machine by combining a speed regulator equation of the virtual synchronous machine; wherein
in the step 1, the microgrid distributed secondary control model based on the virtual synchronous machine is as follows:
$${\dot{θ}}_{ι} ( t ) = {ω}_{i} ( t ) ;$$
$${\dot{ω}}_{ι} ( t ) = \frac{1}{{J}_{i}} ( {P}_{i}^{*} - {P}_{i} ( t ) - {D}_{i} ( {ω}_{i} ( t ) - {ω}_{n i} ( t ) ) ) + {Ω}_{i} ( t ) = {Ω}_{i}^{ω} ( i ) ;$$
wherein θᵢ(t) is a phase of a virtual synchronous machine i; ωᵢ (t) and ωₙᵢ (t) are an output frequency and a frequency setting value of the virtual synchronous machine i, respectively; Jᵢ=J_{Mi}ωₙᵢ (t) is an improved moment of inertia of the virtual synchronous machine i; Dᵢ=k_{ωi}+D_{Mi} is an improved damping coefficient of the virtual synchronous machine i; J_{Mi} and D_{Mi} are a moment of inertia and a damping coefficient of the virtual synchronous machine i, respectively; k_{ωi} is an adjustment coefficient;
$${P}_{i}^{*}$$
is a rated active power of the virtual synchronous machine i; Pᵢ(t) is a mechanical output active power of the virtual synchronous machine i; and Ωᵢ(t) and Ωᵢ^{ω}(t) are an error tracking auxiliary control coefficient and an auxiliary frequency control coefficient of the virtual synchronous machine i, respectively;
ωₙᵢ (t) is as follows:
$${ω}_{n i} ( t ) = \int ( {ψ}_{i} ( t ) + {Ω}_{i} ( t ) - \frac{1}{{k}_{{ω}_{i}}} {φ}_{i}^{P} ( t ) ) dt ;$$
wherein
$${φ}_{i}^{P} ( i )$$
is a derivative or quadratic compensation;
ψᵢ(t) is as follows:
$${ψ}_{i} ( t ) = \frac{1}{{J}_{i}} ( {P}_{i}^{*} - {P}_{i} ( t ) - {D}_{i} ( {ω}_{i} ( t ) - {ω}_{n i} ( t ) ) ) ;$$
step 2: considering nonlinear characteristics of the virtual synchronous machine, based on a deterministic equivalence principle, designing a linearized microgrid distributed secondary control strategy based on the virtual synchronous machine; wherein
in the step 2, the linearized microgrid distributed secondary control strategy based on the virtual synchronous machine is as follows:
$${z}_{i} ( t ) = {\hat{ω}}_{i} ( t ) - {ω}_{i} ( t ) ;$$
$${\dot{\hat{ω}}}_{i} ( t ) = {Ω}_{i}^{\hat{ω}} ( t ) ;$$
$${Ω}_{i} ( t ) = {γ}_{i} {z}_{i} ( t ) - {ψ}_{i} ( t ) + {Ω}_{i}^{\hat{ω}} ( t ) ;$$
wherein zᵢ (t) is an estimated error; \hat{ω}ᵢ(t) is an estimated value of ωᵢ (t); ωᵢ(t) is the output frequency of the virtual synchronous machine i;
$${Ω}_{i}^{\hat{ω}} ( t )$$
is a control variable or reference value tracking; Ωᵢ(t) is the error tracking auxiliary control coefficient of the virtual synchronous machine i; γᵢ is a first control gain; and ψᵢ(t) is as follows:
$${ψ}_{i} ( t ) = \frac{1}{{J}_{i}} ( {P}_{i}^{*} - {P}_{i} ( t ) - {D}_{i} ( {ω}_{i} ( t ) - {ω}_{n i} ( t ) ) ) ;$$
wherein Jᵢ=J_{Mi}ωₙᵢ (t) is the improved moment of inertia of the virtual synchronous machine i; Dᵢ=k_{ωi}+D_{Mi} is the improved damping coefficient of the virtual synchronous machine i, J_{Mi} and D_{Mi} are the moment of inertia and the damping coefficient of the virtual synchronous machine i, respectively; k_{ωi} is the adjustment coefficient; Pᵢ* is the rated active power of the virtual synchronous machine i; Pᵢ(t) is the mechanical output active power of the virtual synchronous machine i; and ωₙᵢ(t) is the frequency setting value of the virtual synchronous machine i;
$${Ω}_{i}^{\hat{ω}} ( t )$$
is as follows:
$${Ω}_{i}^{\hat{ω}} ( t ) = {σ}_{ω} {λ}_{i} ( t ) ;$$
wherein σ_{ω} is a second control gain; and λᵢ(t) is an auxiliary control variable;
λᵢ(t) is as follows:
$${λ}_{i} ( t ) = - {\sum }_{j ∈ {N}_{i}} {a}_{ij} ( {ω}_{i} ( t ) - {ω}_{j} ( t ) ) - {g}_{i 0} ( {ω}_{i} ( t ) - {ω}_{i}^{r e f} ) - {β}_{i} {z}_{i} ( t ) ;$$
wherein Nᵢ is a set of neighbors of the virtual synchronous machine i; αᵢⱼ is a connection gain; gᵢ₀=I means that the virtual synchronous machine i is connected to a reference value; ωᵢ^{ref} is a frequency reference value; and βᵢ is a consensus control gain;
$${ω}_{i}^{r e f}$$
is as follows:
$${ω}_{i}^{r e f} = {lim}_{t \to ∞} {ω}_{i} ( t ) ;$$
wherein i=1, 2, . . . , n; and
step 3: based on the deterministic equivalence principle and a Lyapunov theory, proving an accuracy of frequency recovery of the linearized microgrid distributed secondary control strategy based on the virtual synchronous machine.

2. The microgrid distributed secondary control method based on the virtual synchronous machine according to claim 1, wherein in the step 1, the microgrid primary control strategy based on the virtual synchronous machine is as follows:
$${P}_{i n} ( t ) - {P}_{i} ( t ) = {J}_{M i} {ω}_{n i} ( t ) \frac{d ( {ω}_{i} ( t ) - {ω}_{n i} ( t ) )}{d t} + {D}_{M i} ( {ω}_{i} ( t ) - \tilde{ω} ) ;$$
wherein Pᵢₙ(t) and Pᵢ(t) are a mechanical input active power and the mechanical output active power of the virtual synchronous machine i, respectively; J_{Mi} and D_{Mi} are the moment of inertia and the damping coefficient of the virtual synchronous machine i, respectively; ωᵢ(t) and ωₙᵢ (t) are the output frequency and the frequency setting value of the virtual synchronous machine i, respectively; and \tilde{ω} is a measured angular frequency of the virtual synchronous machine i.

3. The microgrid distributed secondary control method based on the virtual synchronous machine according to claim 1, wherein in the step 1, the speed regulator equation of the virtual synchronous machine is as follows:
$${k}_{ω i} ( {ω}_{n i} ( t ) - {ω}_{i} ( t ) ) = {P}_{i n} ( t ) - {P}_{i}^{*} ;$$
wherein k_{ωi} is the adjustment coefficient; ωᵢ (t) and ωₙᵢ (t) are the output frequency and the frequency setting value of the virtual synchronous machine i, respectively; Pᵢₙ(t) is a mechanical input active power of the virtual synchronous machine i; and
$${P}_{i}^{*}$$
is the rated active power of the virtual synchronous machine i.

4. The microgrid distributed secondary control method based on the virtual synchronous machine according to claim 1, wherein the step 3 of, based on the deterministic equivalence principle and the Lyapunov theory, proving the accuracy of frequency recovery of the linearized microgrid distributed secondary control strategy based on the virtual synchronous machine comprises:
step 3.1: proving that the frequency with ωᵢ(t) approaches a frequency estimate \hat{ω}ᵢ(t); and
step 3.2: proving that the frequency estimate \hat{ω}ᵢ(t) approaches a frequency reference
$${ω}_{i}^{r e f} .$$

5. The microgrid distributed secondary control method based on the virtual synchronous machine according to claim 4, wherein in the step 3.1, the proving that the frequency ωᵢ(t) approaches the frequency estimate ωᵢ(t) comprises:
deriving an estimation error zᵢ (t), as follows:
$${\dot{z}}_{i} ( t ) = {\dot{\hat{ω}}}_{t} ( t ) - {\dot{ω}}_{i} ( t ) = - {γ}_{i} {z}_{i} ( t ) ;$$
defining a Lyapunov function V₁(t), as follows:
$${V}_{1} ( t ) = \frac{1}{2} {z}^{T} z ;$$
wherein z=[z₁,z₂, . . . ,zₙ]^{T}; and T is the transpose;
deriving the lyapunov function V₁(t) to obtain:
$${\dot{V}}_{1} ( t ) = \frac{1}{2} {z}^{T} \dot{z} = - γ ζ \leq 0 ;$$
wherein γ=diag{γᵢ}⊆ [symbol] ^{N×N};
$$ζ = diag \{ {z}_{i}^{2} \} ⊆ {ℝ}^{N \times N} ;$$
γᵢ is the first control gain; and
$${z}_{i}^{2}$$
is a parameter form;
when γᵢ>0, \dot{V}₁(t)<0, and the frequency ωᵢ(t) approaches the frequency estimate \hat{ω}ᵢ(t).

6. The microgrid distributed secondary control method based on the virtual synchronous machine according to claim 4, wherein in the step 3.2, the proving that the frequency estimate \hat{ω}ᵢ(t) approaches the frequency reference
$${ω}_{i}^{r e f}$$
comprises:
defining ñᵢ(t), χᵢ(t), and θᵢ(t), as follows:
$${\tilde{n}}_{i} ( t ) = - {β}_{i} {z}_{i} ( t ) ;$$
$${χ}_{i} ( t ) = {ω}_{i} ( t ) - {ω}_{i}^{r e f} ;$$
$${ϑ}_{i} ( t ) = - {\sum }_{j ∈ {N}_{i}} {a}_{i j} ( {ω}_{i} ( t ) - {ω}_{j} ( t ) ) - {g}_{i 0} ( {ω}_{i} ( t ) - {ω}_{i}^{r e f} ) ;$$
expressing the linearized microgrid distributed secondary control strategy based on the virtual synchronous machine in matrix form, as follows:
$$ω = {σ}_{ω} ϑ + {σ}_{ω} \tilde{n} ;$$
wherein ω is in matrix form; θ=−(L+B)χ; L+B is a matrix form of a connection status; and ñ is in matrix form;
defining a Lyapunov function V₂(t), as follows:
$${v}_{2} ( t ) = \frac{1}{2} {χ}^{T} ( L + B ) χ ;$$
wherein χ=[χ₁,χ₂, . . . ,χ_{N}]^{T};
deriving the lyapunov function V₂(t) to obtain:
$${\dot{V}}_{2} ( t ) = {χ}^{T} ( L + B ) χ ;$$
based on χ=ω and (L+B)^{T}=(L+B), obtaining:
$${\dot{V}}_{2} ( t ) = - {σ}_{ω} {ϑ}^{T} ϑ - {σ}_{ω} {ϑ}^{T} \tilde{n} ;$$
scaling \dot{V}₂(t), and obtaining:
$${\dot{V}}_{2} ( t ) \leq - \frac{{σ}_{ω}}{2} {\sum }_{i = l}^{N} ( {ϑ}_{i}^{2} ( t ) - {\tilde{n}}_{i}^{2} ( t ) ) ;$$
since a convergence parameter μᵢ satisfies
$${ϑ}_{i}^{2} ( t ) < {μ}_{i} {\tilde{n}}_{i}^{2} ( t )$$
and μᵢ>1, obtaining:
$${\dot{V}}_{2} ( t ) \leq - \frac{{σ}_{ω}}{2} {\sum }_{i = l}^{N} ( {μ}_{i} - l ) {\tilde{n}}_{i}^{2} ( t ) \leq 0 ;$$
wherein \dot{V}₂(t) is strictly negative semi-definite, and the frequency estimate \hat{ω}ᵢ(t) approaches the frequency reference
$${ω}_{i}^{ref} .$$

7. A microgrid distributed secondary control system based on a virtual synchronous machine using the microgrid distributed secondary control method based on the virtual synchronous machine according to claim 1, comprising:
an establishment module for a microgrid distributed secondary control model based on the virtual synchronous machine, configured to, design a microgrid primary control strategy based on the virtual synchronous machine, and establish the microgrid distributed secondary control model based on the virtual synchronous machine by combining a speed regulator equation of the virtual synchronous machine;
a designing module for a linearized microgrid distributed secondary control strategy based on the virtual synchronous machine, configured to, consider nonlinear characteristics of the virtual synchronous machine, and based on a deterministic equivalence principle, design the linearized microgrid distributed secondary control strategy based on the virtual synchronous machine; and
a frequency recovery accuracy proof module, configured to, based on the deterministic equivalence principle and a Lyapunov theory, prove an accuracy of frequency recovery of the linearized microgrid distributed secondary control strategy based on the virtual synchronous machine.

8. The microgrid distributed secondary control system based on the virtual synchronous machine according to claim 7, wherein in the step 1 of the microgrid distributed secondary control method based on the virtual synchronous machine, the microgrid primary control strategy based on the virtual synchronous machine is as follows:
$${P}_{in} ( t ) - {P}_{i} ( t ) = {J}_{Mi} {ω}_{ni} ( t ) \frac{d ( {ω}_{i} ( t ) - {ω}_{ni} ( t ) )}{dt} + {D}_{Mi} ( {ω}_{i} ( t ) - \tilde{ω} ) ;$$
wherein Pᵢₙ(t) and Pᵢ(t) are a mechanical input active power and the mechanical output active power of the virtual synchronous machine i, respectively; J_{Mi} and D_{Mi} are the moment of inertia and the damping coefficient of the virtual synchronous machine i, respectively; ωᵢ(t) and ωₙᵢ (t) are the output frequency and the frequency setting value of the virtual synchronous machine i, respectively; and \tilde{ω} is a measured angular frequency of the virtual synchronous machine i.

9. The microgrid distributed secondary control system based on the virtual synchronous machine according to claim 7, wherein in the step 1 of the microgrid distributed secondary control method based on the virtual synchronous machine, the speed regulator equation of the virtual synchronous machine is as follows:
$${k}_{ω i} ( {ω}_{ni} ( t ) - {ω}_{i} ( t ) ) = {P}_{in} ( t ) - {P}_{i}^{*} ;$$
wherein k_{ωi} is the adjustment coefficient; ωᵢ (t) and ωₙᵢ (t) are the output frequency and the frequency setting value of the virtual synchronous machine i, respectively; Pᵢₙ(t) is a mechanical input active power of the virtual synchronous machine i; and
$${P}_{i}^{*}$$
is the rated active power of the virtual synchronous machine i.

10. The microgrid distributed secondary control system based on the virtual synchronous machine according to claim 7, wherein in the microgrid distributed secondary control method based on the virtual synchronous machine, the step 3 of, based on the deterministic equivalence principle and the Lyapunov theory, proving the accuracy of frequency recovery of the linearized microgrid distributed secondary control strategy based on the virtual synchronous machine comprises:
step 3.1: proving that the frequency ωᵢ(t) approaches a frequency estimate \hat{ω}ᵢ(t); and
step 3.2: proving that the frequency estimate \hat{ω}ᵢ(t) approaches a frequency reference
$${ω}_{i}^{ref} .$$

11. The microgrid distributed secondary control system based on the virtual synchronous machine according to claim 10, wherein in the step 3.1, the proving that the frequency with ωᵢ(t) approaches the frequency estimate \hat{ω}ᵢ(t) comprises:
deriving an estimation error zᵢ(t), as follows:
$${\dot{z}}_{i} ( t ) = {\dot{\hat{ω}}}_{t} ( t ) - {\dot{ω}}_{i} ( t ) = - {γ}_{i} {z}_{i} ( t ) ;$$
defining a Lyapunov function V₁(t), as follows:
$${V}_{l} ( t ) = \frac{l}{2} {z}^{T} z ;$$
wherein z=[z₁,z₂, . . . ,zₙ]^{T}; and T is the transpose;
deriving the lyapunov function V₁(t) to obtain:
$${\dot{V}}_{l} ( t ) = \frac{l}{2} {z}^{T} \dot{z} = - γ ζ \leq 0 ;$$
wherein γ=diag{γᵢ}⊆ [symbol] ^{N×N};
$$ζ = diag \{ {z}_{i}^{2} \} ⊆ {ℝ}^{N \times N} ;$$
γᵢ is the first control gain; and
$${z}_{i}^{2}$$
is a parameter form;
when γᵢ>0, \dot{V}₁(t)<0, and the frequency ωᵢ(t) approaches the frequency estimate \hat{ω}ᵢ(t).

12. The microgrid distributed secondary control system based on the virtual synchronous machine according to claim 10, wherein in the step 3.2, the proving that the frequency estimate \hat{ω}ᵢ(t) approaches the frequency reference
$${ω}_{i}^{ref}$$
comprises:
defining ñᵢ(t), ωᵢ(t), and θᵢ(t), as follows:
$${\tilde{n}}_{i} ( t ) = - {β}_{i} {z}_{i} ( t ) ;$$
$${χ}_{i} ( t ) = {ω}_{i} ( t ) - {ω}_{i}^{ref} ;$$
$${ϑ}_{i} ( t ) = - {\sum }_{j ∈ {N}_{i}} {a}_{ij} ( {ω}_{i} ( t ) - {ω}_{j} ( t ) ) - {g}_{i 0} ( {ω}_{i} ( t ) - {ω}_{i}^{ref} ) ;$$
expressing the linearized microgrid distributed secondary control strategy based on the virtual synchronous machine in matrix form, as follows:
$$ω = {σ}_{ω} ϑ + {σ}_{ω} \tilde{n} ;$$
wherein ω is in matrix form; θ=−(L+B)χ; L+B is a matrix form of a connection status; and ñ is in matrix form;
defining a Lyapunov function V₂(t), as follows:
$${V}_{2} ( t ) = \frac{1}{2} {χ}^{T} ( L + B ) χ ;$$
wherein χ=[χ₁,χ₂, . . . ,χ_{N}]^{T};
deriving the lyapunov function V₂(t) to obtain:
$${\dot{V}}_{2} ( t ) = {χ}^{T} ( L + B ) χ ;$$
based on χ=ω and (L+B)^{T}=(L+B), obtaining:
$${\dot{V}}_{2} ( t ) = - {σ}_{ω} {ϑ}^{T} ϑ - {σ}_{ω} {ϑ}^{T} \tilde{n} ;$$
scaling \dot{V}₂(t), and obtaining:
$${\dot{V}}_{2} ( t ) \leq - \frac{{σ}_{ω}}{2} {\sum }_{i = 1}^{N} ( {ϑ}_{i}^{2} ( t ) - {\tilde{n}}_{i}^{2} ( t ) ) ;$$
since a convergence parameter μᵢ satisfies
$${ϑ}_{i}^{2} ( t ) < {μ}_{i} {\tilde{n}}_{i}^{2} ( t )$$
and μᵢ>1, obtaining:
$${\dot{V}}_{2} ( t ) \leq - \frac{{σ}_{ω}}{2} {\sum }_{i = 1}^{N} ( {μ}_{i} - 1 ) {\tilde{n}}_{i}^{2} ( t ) \leq 0 ;$$
wherein \dot{V}₂(t) is strictly negative semi-definite, and the frequency estimate \hat{ω}ᵢ(t) approaches the frequency reference
$${ω}_{i}^{ref} .$$
